(19) United States
(12) Patent Application Publication
(10) Pub. No.: US 2009/0272091 A1
(43) Pub. Date: Nov. 5, 2009

(54) Manual lawn mower

(76) Inventor: Nadir Sharaf, Erie, PA (US)

Correspondence Address: Nadir Sharaf, 2915 Idyllbrook Lane, Erie, PA, 16506, US

(21) Appl. No.: 12/150,516

(22) Filed: Apr. 30, 2008

(51) Int. Cl. A01D 34/08

(52) U.S. Cl. 56/263

(57) ABSTRACT

A unique lawn mower that relies on operator's power to cut the grass, without polluting the environment or causing health hazards. It comprises of a plurality of shear blades held together by fasteners and springs. The grass cutting is accomplished by shearing entrapped grass between the shear blade notches. The rotational motion of the drive wheel is converted into back-and-forth translational motion by a unique design. The back and forth motion is used to slide one shear blade over the other. The height of grass to be cut can be changed by an adjustment handle, which resides on support links. The support links carry a rear wheel that provides stability to the mower and provide bearing surface for the drive tube generating the translational motion.

### FIELD OF INVENTION

The present invention relates to a lawn mower, more particularly to a manual lawn mower that does not rely on a gas-powered engine for its primary function.

### BACKGROUND OF INVENTION

A typical lawn mower is used to cut or mow the grass around a house to beautify a yard. In some communities, the law requires not to grow the grass beyond a certain length. Keeping the grass to shorter lengths may also promote greater grass health.

The lawn mowers can be divided into two categories; a manual lawn mower and a motorized law mower. In both cases, the grass cutting action is obtained by subjecting the grass to a sharp edged blade or blades. In the manual lawn mowers typically reel type—the cutting is obtained by shearing the grass leaves between two blades. The relative motion of the blades causes shearing of the entrapped grass. The motion of these blades is obtained through complex mechanisms using rotational motion of the wheels on which the whole machine resides. In the motorized lawn mowers—the cutting is obtained by subjecting the grass a set of blades moving in a quick rotating fashion. In this case, the motion is imparted from a prime mover such as an internal combustion engine.

The manual lawn mowers, typically reel type, offer an environmentally friendly lawn mowing operation, as they do not use gasoline, lube oil, etc. In addition, relative to the motorized lawn mower the manual law mowers are less noisy and do not impose a long-term hearing impairment hazard. These are also lighter weight. One of the disadvantages associated with these grass-cutting machines is that it takes longer compared with the motorized type to mow same yard. They are also not effective in cutting the weed. The reel type lawn mower relies on complex gearing for motion transmission and achieving the high speed required to fulfill its primary function.

Motorized lawn mowers consume gasoline and oil is required to lubricate the engine. In case of a two-stroke engine, the lube oil is burned with the fuel and the resulting exhaust emissions cause additional damage to the environment. Filling the gas tank and routine maintenance such as oil change requires time. The ever-increasing price of gasoline and oil is also a concern.

Starting the engine requires pulling a string and that could cause body harm. Due to its weight, pushing the lawn mover to cover the lawn area requires considerable force and operators are somewhat exhausted after mowing the lawn. The engine is very loud and can cause hearing impairment over a long-term period. The fumes from the burned gasoline/oil can easily get into to lungs of the operator and may pose serious health risks. The speed of the blades is extremely high as these lawn mowers rely on high speed. Numerous accidents are reported each year as a result of the operation of these lawn mowers.

Extensive patent search did not yield any invention that overcomes the above problems and compares with the design proposed in this disclosure. The present invention provides a novel lawn mower that which solves these and many other problems associated with lawn mowing.

### SUMMARY OF THE INVENTION

The present invention relates to a lawn mower, more particularly to a manual lawn mower that does not rely on a gas-powered engine for mowing and is easy to use.

In one embodiment, the present invention comprises of two shear blades where one is placed on top of other and are held together with the help of fasteners and springs. A preload of the springs provide a force that keeps them together so the entrapped grass can be cut. These shear blades have V-shaped notches at one end and these notches align with each other to entrap grass at some point in the operation. One shear blade is moveable relative to the other one and when the shear blades slide on each other, the grass is sheared by being placed in these notches. A pin is attached to the moveable shear blade. This pin is disposed between two pieces of tubing. These pieces of tubing have a pattern machined on them at one end such that when they rotate, the rotational motion causes the pin to move back and forth. As the pin is attached to the moveable blade, the blade also moves with it.

Still in one embodiment, the patterned-machined tubes are attached to a drive tube, which carry drive wheels. As the mower is pushed to roll on these drive wheels, the friction between the ground/grass and the wheels cause these wheels to roll. The rolling motion is transmitted to the patterned machine tube by the drive tube, which in turn causes the above mentioned pin to move back and forth thus cause relative motion between the moveable shear blade and the stationary shear blade.

Further, in one embodiment, a ring is disposed between the pin and the surface of the machined tube. This ring will enable free motion of the pin by offering either a sliding or a rotational motion on the contact surface between the ring and the machined tube. In addition, it will enable only rotational motion between the pin and the pair of tubes.

Yet, in one embodiment, a different set of tubes carries the patterned tubes by providing a bearing surface. These tubes support the driver tubes and provide a surface where the drive tubes can freely rotate.

Still in one embodiment, each support tube is connected to the rear wheel by link. This link serves many purposes. It provides a place where a push handle may be attached. The push handle can rotate on two pin attached to this link. The push handles are used to transmit a force that enable the mower to move forward. These links also form a rectangular slot that allows insertion of an angle bracket, which carries the stationary shear blade. The angle bracket carries the stationary shear blade on one end and provides a place to attach a link that is used to adjust the cutting height of the grass. A link, with various heights and capable of pivoting on the angle bracket, is attached to the angle bracket such that the stationary blade with moveable blade and the pin can move up and down relative to the sliding direction. A portion of this link serves as a handle.

Yet, in one embodiment, a rear wheel in sandwiched between the support links that provides a three-point support for the whole lawn mower and helps ensure the horizontality of the shearing blades and the height of the cutting grass.

### BRIEF DESCRIPTION OF THE DRAWINGS

In the drawings, in which like reference numerals and letters generally indicate corresponding parts throughout the following several views:

FIG. 1 is a perspective view of one embodiment of a lawn mower.

FIG. 2 is a perspective view of one embodiment of a lawn mower without push handles and shows the engagement of the ring, the pin, and the pattern generator parts.

FIG. 3 is a perspective view of one embodiment of a lawn mower.

FIG. 4 is a perspective exploded view of one embodiment of a lawn mower without push handles and illustrates the cavity in the support link.

FIG. 5 shows the zigzag pattern generated by rotation of drive wheels.

FIG. 6A is a top plan view of the mower showing moveable shear blade in one extreme position

FIG. 6B is a top plan view of the mower showing moveable shear blade in an intermediate position

FIG. 6C is a top plan view of the mower showing moveable shear blade in the other extreme position

FIG. 7A is side view of the lawn mower illustrating height adjustment feature

FIG. 7B is side view of the lawn mower illustrating height adjustment feature

FIG. 7C is side view of the lawn mower illustrating height adjustment feature

### DETAILED DESCRIPTION OF THE PREFERRED EMBODIMENT

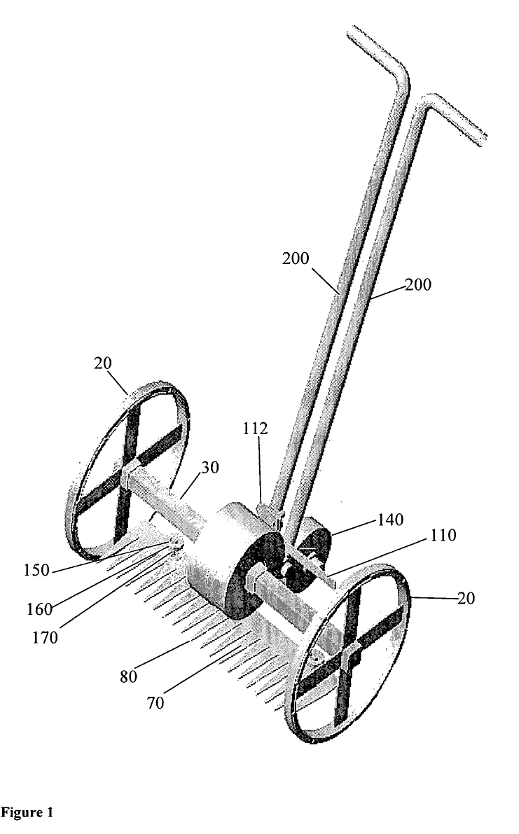

Referring now to the drawings in detail, wherein like numerals identify similar elements throughout, FIG. 1 shows an embodiment of a manual lawn mower in accordance with the principles of the present invention. The lawn mower comprises of a set of two wheels 20 which are attached to a driver tube 30 square in cross-section.

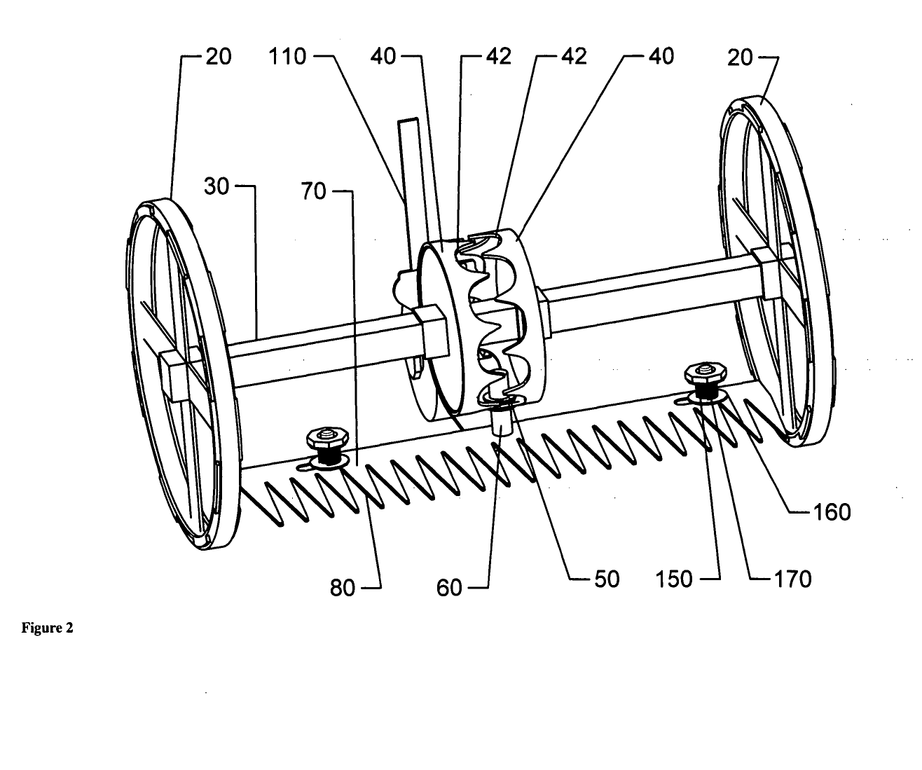

FIG. 2 shows at least one set of zigzag pattern generators 40 is placed towards the middle of the drive tube 30. A ring 50 is disposed between these two pieces 40, which can either rotate or slide on the surface 42 of the pattern generators 40. Attention is now drawn towards the pin 60, which is disposed inside the hole in ring 50 and can freely rotate within the ring, as illustrated in FIG. 2. The pin 60 is attached to a moveable shear blade 70 with V-notches one side. A set of fasteners 150, washers 160, and springs 170 keep the moveable shear blade squeezed towards the stationary shear blade 80. Since moveable shear blade 70 is overlapping the stationary shear blade 80 in FIG. 2, stationary shear blade 80 is not distinctly visible. The stationary shear blade 80 also has similar V-notches.

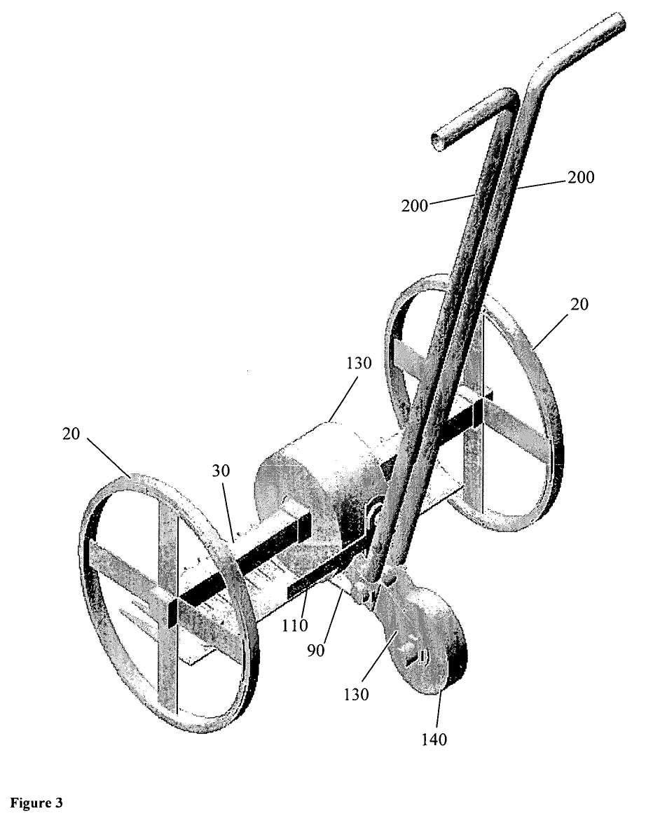

FIG. 3 illustrates how the assembly of moveable shears blade 70, stationary shears blade 80, fasteners 150, washers 160, springs 170 are attached to the support links 130 using an angle bracket 90. At the end of angle bracket 90, a handle 110 capable of pivoting in the hole in angle bracket 90 is provided. The handle 110 may slide in the slot 134 formed by fastening two support links 130, together. The surface 112 of the handle rests on slot 134.

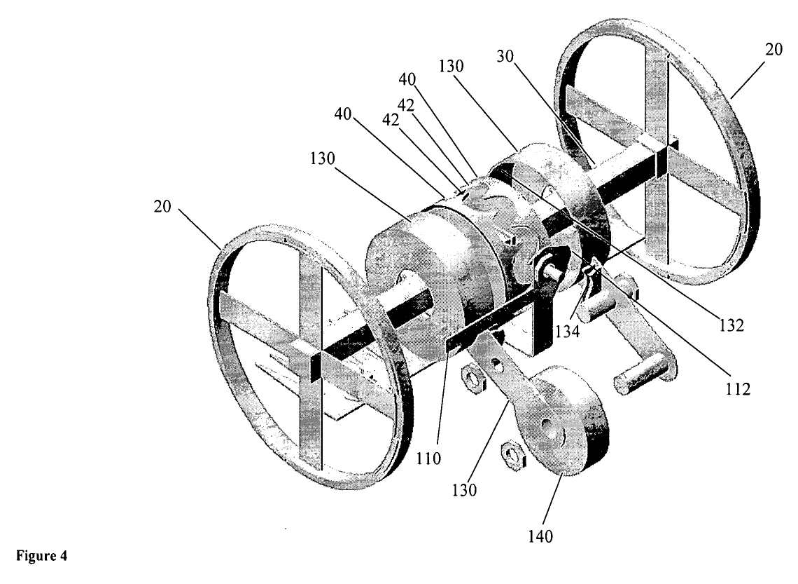

Attention is now drawn to FIG. 4 that shows the hollow cavity provided on one side of each of the support links 130, which acts as the main bearing surface 132 for drivers 40. Rear wheel 140 is disposed between the remaining ends of support links 130. The rear wheel allows rolling of the lawn mower as well as the stability and maintenance of the grass cutting height.

As shown in FIG. 3, push handles 200 are also attached to the support links 130 to provide the driving force to the lawn mower. Further wipers can be attached to the driving tube 30 that can wipe the grass accumulated on the top of moveable shear blade. A basket can also be provided for catching the grass clippings if so desired.

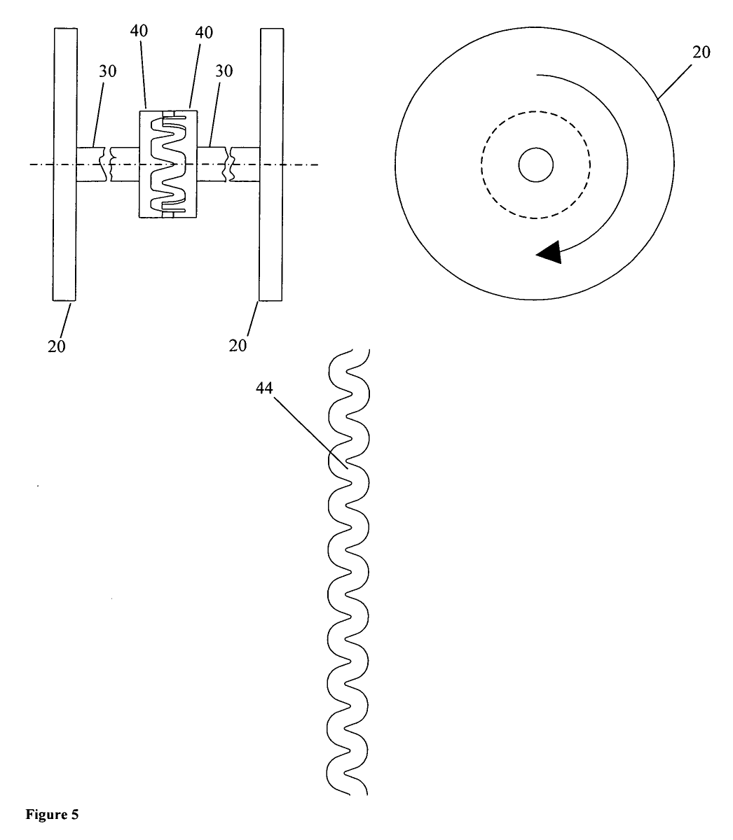

Attention is drawn towards FIG. 5 that describes the function of the present invention. As a push force is applied on the handles 200, the drive wheels 20 will rotate on the ground or grass. The rotation of drive wheels 20 will cause the drive tube 30 to rotate with it in the same direction. Since the zigzag pattern generators 40 are rigidly attached to drive tube 30, they will also rotate and their rotation will inscribe a zigzag path 44 similar to the one shown in FIG. 4. As illustrated in FIG. 2, ring 50 and the pin 60 will trace this path, however due to the movement constraints imposed on the angle bracket 90 by slot 134, the moveable blade 70 can only move back and forth, perpendicular to the direction of motion.

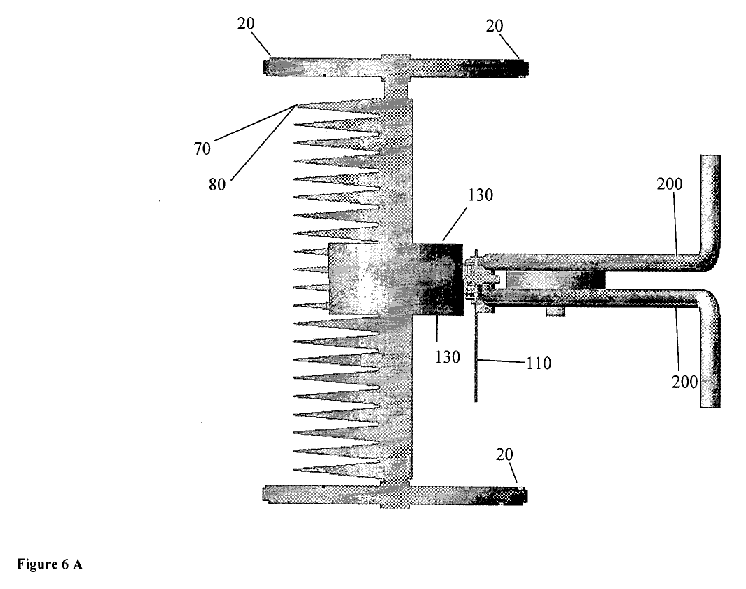

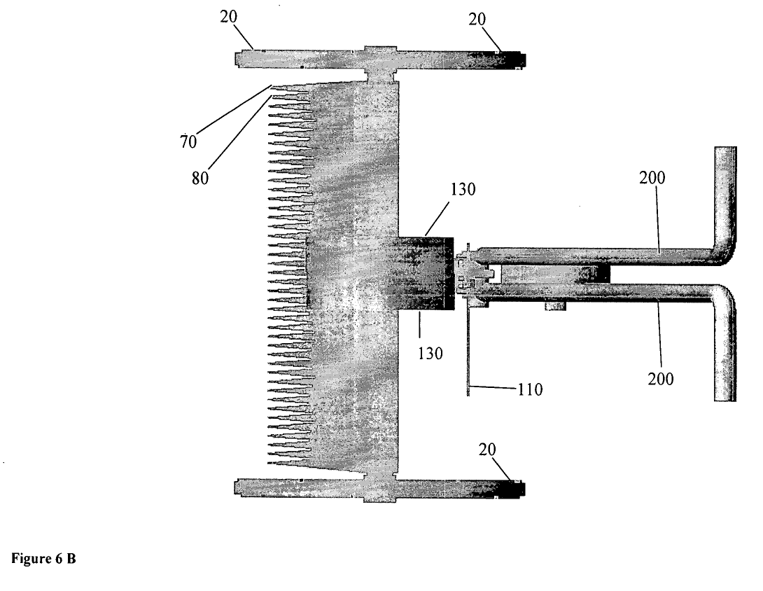

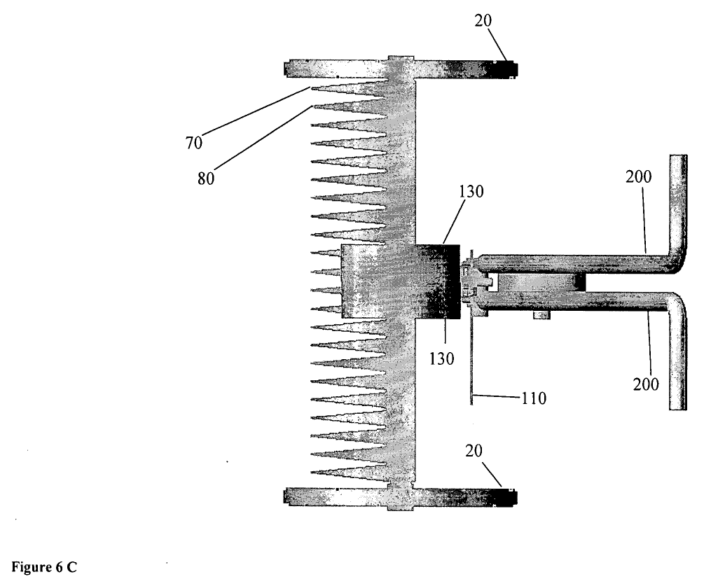

The slot and pin arrangement between the moveable shear blade 70 and the stationary shear blade, however allows relative sliding motion between these two components. The back and forth motion of the pin will cause the moveable shear blade 70 to slide over the stationary shear blade, as shown in FIGS. 6A, 6B, and 6C. As the lawn mower rolls forward, grass will be entrapped between the V-notches provided in the shear blades 70, and 80. This entrapped grass will be cut due to shearing action. FIG. 6A shows the relative position of the moveable shear blade 70 and the stationary shear blade 80 in one extreme. FIG. 6B shows the relative position of the moveable shear 70 blade and the stationary shear blade 80 in an intermediate position. FIG. 6C shows the relative position of the moveable shear blade 70 and the stationary shear blade 80 in the other extreme.

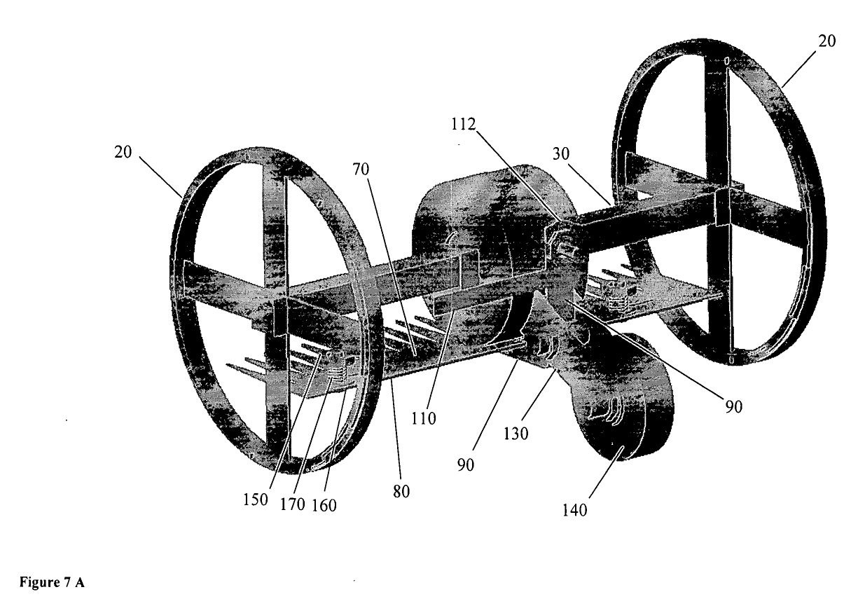

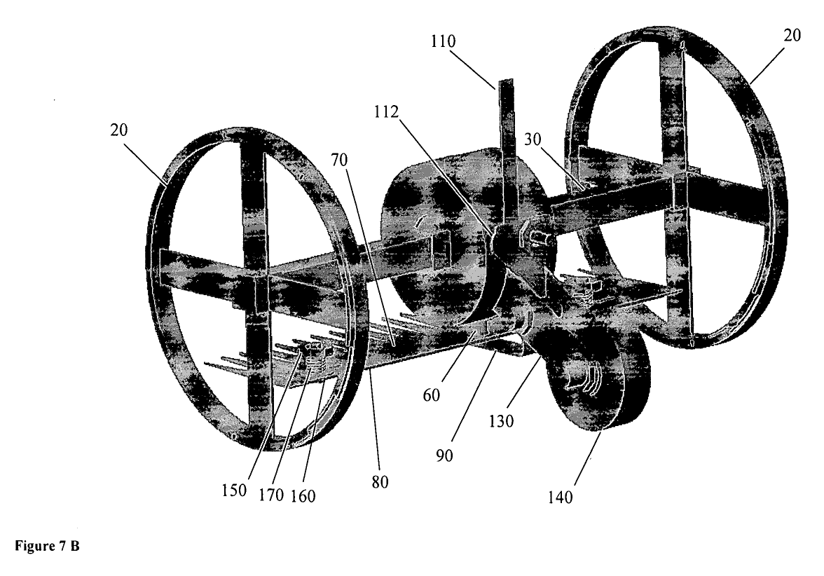

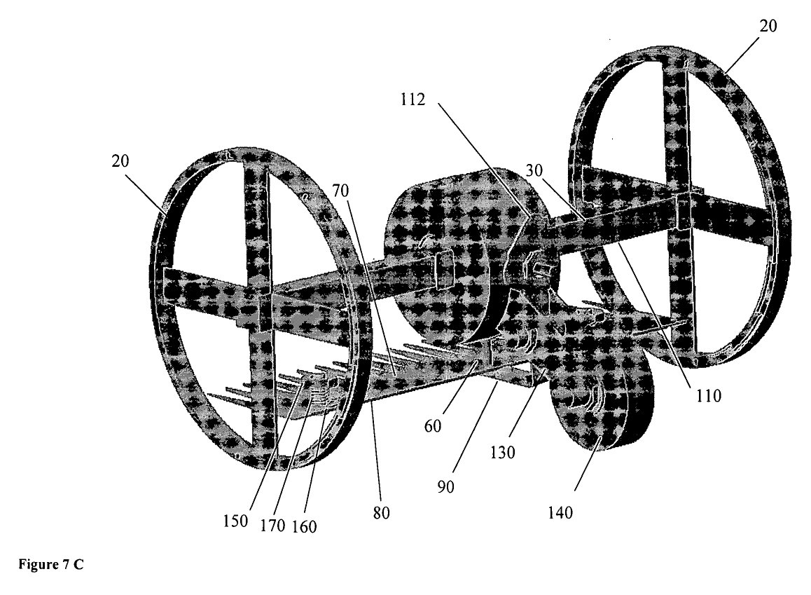

FIGS. 7A, 7B and 7C show the height adjustment capability of the lawn mower. The adjustment handle 110 can be rotated in three stable positions and the whole assembly of moveable shear blade 70, stationary shear blade 80, fasteners 150, washers 160, and springs 170, ring 50 and pin 60. Surface 112 of the handle 110 will sit in the notch formed by upper surface of the sliding slot 134 of the support link 130 shown in FIG. 4.

It will be appreciated that alternate embodiments in keeping with principles of the present invention might be utilized. It is to be understood, however, that even though numerous characteristics and advantages of the invention have been set forth in the foregoing description, together with details of the structure and function the invention, the disclosure is illustrative only, and changes may be made in detail, especially in matters of shape, size, and arrangement of parts, within the principles of the invention, to the full extent indicated by the broad general meeting of the terms in which the appended claims are expressed.

What is claimed is:

1. A lawn mower, comprising:
A set of wheels driving a tube where two parts are attached to the drive tube such that their rotational motion creates a zigzag motion in direction perpendicular to the parts.
At least one ring and pin so that the ring can both slide and rotate on the zigzag path created by the parts above and the pin can freely rotate inside the ring.
At least one set of shear blades where one is placed upon the other one. With the pin attached to the moveable shear blade so that the shear blade slides back and forth with the pin. The shear blades are held together with fasteners and spring so they exert some force on each other.
A bracket that supports the set of shear blades and allows height adjustment so that the height of the grass to be cut can be controller.
A set of tubes that supports the zigzag motion producing parts and provides bearing surfaces.
A set of links that connect the support tubes to a rear wheel providing a three-point support to the lawn mower.
The support links also form a channel to provide support to the bracket supporting the shear blade assembly.
The support links providing a place for push handle support.
The support links providing a place for attachment to a cover, and a grass catching basket.

2. A lawn mower according to claim 1 that utilizes manual power to cut the grass, where the rotational motion of a pair of tubes so machined that they create a zigzag pattern changed into translational motion.

3. A lawn mower according to claim 1, that where the translational motion is imparted to a pin with a ring disposed between the pin and the pair of tubes.

4. A lawn mower according to claim 1, that where a moveable shear blade is attached to the pin and the moveable blade slides over a stationary blade and cuts the entrapped grass.

5. A lawn mower according to claim 1, that where the set of moveable shear blade and the stationary blade can be moved up and down to adjust the grass cutting height.

6. A lawn mower according to claim 1, that that allows changing the cutting height of the grass.

7. A mechanism that converts the rotational motion into translational motion.

8. A mechanism according to claim 7 that utilizes two machined parts to create a zigzag pattern.

9. A mechanism according to claim 8, that utilizes two machined parts to create a zigzag motion with a ring disposed between these parts to create the zigzag motion.
